(19) United States
(12) Patent Application Publication
(10) Pub. No.: US 2021/0264689 A1
(43) Pub. Date: Aug. 26, 2021

(54) VEHICLE ERROR ALERTING SYSTEM

(71) Applicant: Ford Global Technologies, LLC, Dearborn, MI (US)

(72) Inventors: Linjun Zhang, Canton, MI (US); Helen Elizabeth Kourous-Harrigan, Monroe, MI (US); Qi Chen, Canton, MI (US); Lu Xu, Canton, MI (US)

(73) Assignee: Ford Global Technologies, LLC, Dearborn, MI (US)

(21) Appl. No.: 16/799,171

(22) Filed: Feb. 24, 2020

(51) Int. Cl. G07C 5/00; B60W 60/00; H04W 4/12; H04W 4/46; H04W 4/44

(52) U.S. Cl. CPC G07C 5/008; B60W 60/0053; H04W 4/44; H04W 4/46; H04W 4/12

(57) ABSTRACT

The present disclosure discloses a system and a method. In an example implantation, the system and the method can provide a message to a first communications module. The first communications module is configured to transmit the message. The system and the method can also include determining whether the message has been received from a second communications module, and determining whether to generate a warning message based on the determination of whether the message has been received from the second communications module.

### BACKGROUND

Many devices, including vehicles, include navigation systems that use satellite-transmitted data to determine their latitude, longitude, and altitude. For example, in the United States, the Global Positioning System (GPS) is one example of these types of satellite navigation systems that collectively known as Global Navigation Satellite Systems (GNSS). These devices can use the location data for navigation purposes, determining its current position, and the like. Additionally, vehicles may employ vehicle-to-vehicle (V2V) and vehicle-to-infrastructure (V2I) communications for communication purposes.

### BRIEF DESCRIPTION OF THE DRAWINGS

FIG. 1 is a diagram of an example system.

FIG. 2A is a diagram of an example vehicle including a first communications module and a second communications module.

FIG. 2B is a diagram of an example smart infrastructure computing device including a first communications module and a second communications module.

FIG. 3 is a flowchart illustrating an example process for determining whether the first communications module is operational.

FIG. 4 is a flowchart illustrating an example process for determining whether sensor data received at one or more vehicle sensors is accurate.

FIG. 5 is a flowchart illustrating an example processor for determining whether a sufficient number of Global Positioning System (GPS) signals have been received.

### DETAILED DESCRIPTION

A system can include a first communications module and a second communications module communicatively coupled to the first communications module. The system can also include a computer including a processor and a memory, the memory including instructions such that the processor is programmed to: provide a message to the first communications module, wherein the first communications module is configured to transmit the message; determine whether the message has been received from the second communications module; and determine whether to generate a warning message based on the determination of whether the message has been received from the second communications module.

In other features, the processor is further programmed to calculate a message latency corresponding to the message.

In other features, the processor is further programmed to calculate the message latency corresponding to the message by subtracting a received timestamp (rx_timestamp) from a transmission timestamp (tx_timestamp).

In other features, the processor is further programmed to determine whether the message latency is greater than a predetermined latency threshold.

In other features, the processor is further programmed to generate the warning message when the message latency is greater than the predetermined latency threshold.

In other features, the processor is further programmed to cause the warning message to be transmitted via a wireless network to a server.

In other features, the processor is further programmed to cause the vehicle to transition from an autonomous mode to a non-autonomous mode.

In other features, the processor is further programmed to compare source identification information for the message to a system identification to determine whether to calculate the message latency.

In other features, the processor is further programmed to actuate an autonomous vehicle based on the warning message.

In other features, the second communications module operates in a receiver-only mode.

A method comprises providing a message to a first communications module, wherein the first communications module is configured to transmit the message; determining whether the message has been received from a second communications module; and determining whether to generate a warning message based on the determination of whether the message has been received from the second communications module.

In other features, the method includes calculating a message latency corresponding to the message.

In other features, the method includes calculating the message latency corresponding to the message by subtracting a received timestamp (rx_timestamp) from a transmission timestamp (tx_timestamp).

In other features, the method includes determining whether the message latency is greater than a predetermined latency threshold.

In other features, the method includes generating the warning message when the message latency is greater than the predetermined latency threshold.

In other features, the method includes causing the warning message to be transmitted via a wireless network to a server.

In other features, the method includes causing a vehicle to transition from an autonomous mode to a non-autonomous mode based on the warning message.

In other features, the method includes comparing source identification information for the message to a system identification to determine whether to calculate the message latency.

In other features, the method includes actuating an autonomous vehicle based on the warning message.

In other features, the second communications module operates in a receiver-only mode.

Vehicles have increasingly begun to employ vehicle-to-vehicle (V2V) and vehicle-to-infrastructure (V2I) communications, collectively known as V2X, for communication purposes. For example, V2X communications include one or more communication networks in which vehicles and roadside devices are the communicating nodes that provide one another with information, such as safety warnings and traffic information. V2X communications allow vehicles to communicate with other vehicles, infrastructure, and/or pedestrians, using wireless communications technologies, such as, but not limited to, Dedicated Short Range Communications (DSRC).

Intelligent transportation systems (ITS) can use V2X services within and/or around intersection environments, such as signalized intersection environments. For example, the V2X services may use survey level map representations of the intersections to allow vehicles to locate themselves with respect to the different approach lanes. As a vehicle approaches the intersections, traffic control systems signals broadcast signals, such as Signal Phase and Timing (SPaT) messages, to provide traffic signal information to approaching vehicles. However, some intersections include multiple turning lanes. Thus, the traffic signals broadcast different SPaT message elements (e.g., signals) pertaining to each approach lane. Additionally, vehicles and other devices within the environment may broadcast Basic Safety Messages to surrounding devices and/or vehicles for collaborative motion planning and decision making.

The present disclosure is directed to a system that allows a vehicle or a computing device deployed within a smart infrastructure environment to perform error identification and/or error alerting. In an example implementation, a vehicle or a smart infrastructure computing device can employ at least two communications modules. A first communications module is configured to broadcast and/or transmit messages, and a second communications module is configured to receive messages broadcast by the first communications module. A computer within the vehicle or the computing device can monitor a status of the first communications module based on messages provided to the computer from the first communications module. Additionally or alternatively, the system may be configured to determine whether sensor data received at one or more vehicle sensors is accurate and/or whether a sufficient number of Global Positioning System (GPS) signals have been received.

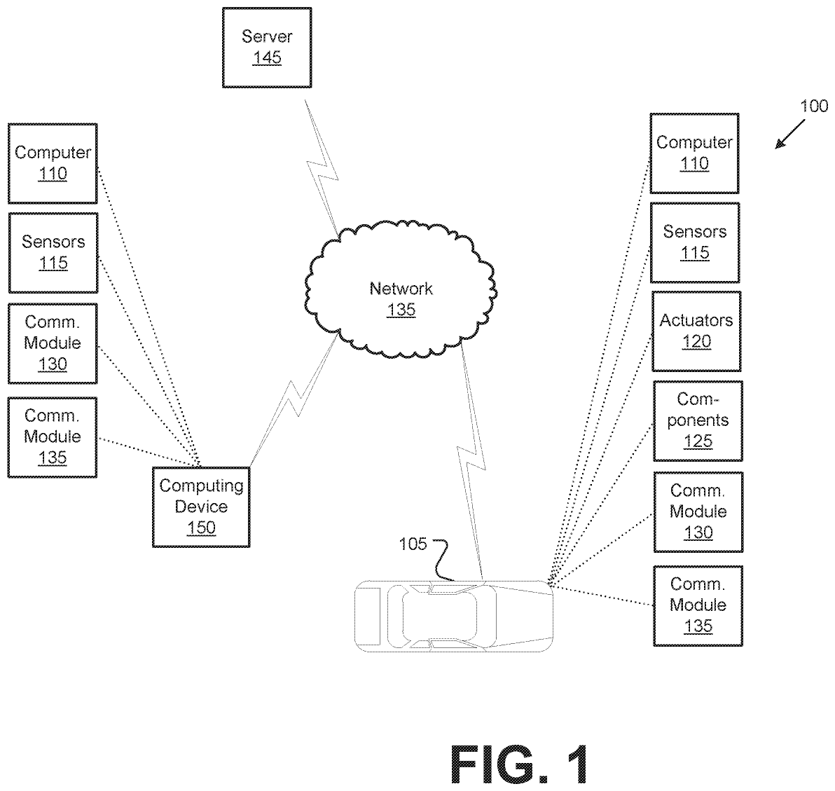

FIG. 1 is a block diagram of an example system 100. The system 100 includes a vehicle 105, which is a land vehicle such as a car, truck, etc. and a computing device 150. The vehicle 105 includes a computer 110, sensors 115, actuators 120 to actuate various vehicle components 125, a first communications module 130, and a second communications module 135. Via a network 140, the communications module 130 allows the computer 110 to communicate with a server 145.

The computing device 150 represents a device utilized within the intelligent transformation systems. The computing device 150 can represent, but is not limited to, any computing device that communicates with vehicles within the vehicle environment. For example, the computing device 150 may be an intelligent roadside device, an intelligent traffic signal, or any other intelligent device within a smart infrastructure. As shown, the computing device 150 includes a computer 110, sensors 115, a first communications module 130, and a second communications module 135.

The computer 110 includes a processor and a memory. The memory includes one or more forms of computer-readable media, and stores instructions executable by the computer 110 for performing various operations, including as disclosed herein.

The computer 110 may operate the vehicle 105 in an autonomous, a semi-autonomous mode, or a non-autonomous (manual) mode. For purposes of this disclosure, an autonomous mode is defined as one in which each of vehicle 105 propulsion, braking, and steering are controlled by the computer 110; in a semi-autonomous mode the computer 110 controls one or two of vehicles 105 propulsion, braking, and steering; in a non-autonomous mode a human operator controls each of vehicle 105 propulsion, braking, and steering.

The computer 110 may include programming to operate one or more of vehicle 105 brakes, propulsion (e.g., control of acceleration in the vehicle by controlling one or more of an internal combustion engine, electric motor, hybrid engine, etc.), steering, climate control, interior and/or exterior lights, etc., as well as to determine whether and when the computer 110, as opposed to a human operator, is to control such operations. Additionally, the computer 110 may be programmed to determine whether and when a human operator is to control such operations.

The computer 110 may include or be communicatively coupled to, e.g., via the communications module 130 as described further below, more than one processor, e.g., included in electronic controller units (ECUs) or the like included in the vehicle 105 for monitoring and/or controlling various vehicle components 125, e.g., a powertrain controller, a brake controller, a steering controller, etc. Further, the computer 110 may communicate, via the vehicle 105 communications module 130, with a navigation system that uses the Global Position System (GPS). As an example, the computer 110 may request and receive location data of the vehicle 105. The location data may be in a known form, e.g., geo-coordinates (latitudinal and longitudinal coordinates).

The computer 110 is generally arranged for communications on the vehicle 105 communications module 130 and also with a vehicle 105 internal wired and/or wireless network, e.g., a bus or the like in the vehicle 105 such as a controller area network (CAN) or the like, and/or other wired and/or wireless mechanisms.

Via the vehicle 105 communications network, the computer 110 may transmit messages to various devices in the vehicle 105 and/or receive messages from the various devices, e.g., vehicle sensors 115, actuators 120, vehicle components 125, a human machine interface (HMI), etc. Alternatively or additionally, in cases where the computer 110 actually comprises a plurality of devices, the vehicle 105 communications network may be used for communications between devices represented as the computer 110 in this disclosure. Further, as mentioned below, various controllers and/or vehicle sensors 115 may provide data to the computer 110.

Sensors 115 may include a variety of devices such as are known to provide data to the computer 110. For example, the vehicle sensors 115 may include Light Detection and Ranging (lidar) sensor(s) 115, etc., disposed on a top of the vehicle 105, behind a vehicle 105 front windshield, around the vehicle 105, etc., that provide relative locations, sizes, and shapes of objects and/or conditions surrounding the vehicle 105. As another example, one or more radar sensors 115 fixed to vehicle 105 bumpers may provide data to provide and range velocity of objects (possibly including second vehicles 106), etc., relative to the location of the vehicle 105. The vehicle sensors 115 may further include camera sensor(s) 115, e.g. front view, side view, rear view, etc., providing images from a field of view inside and/or outside the vehicle 105.

The vehicle 105 actuators 120 are implemented via circuits, chips, motors, or other electronic and or mechanical components that can actuate various vehicle subsystems in accordance with appropriate control signals as is known. The actuators 120 may be used to control components 125, including braking, acceleration, and steering of a vehicle 105.

In the context of the present disclosure, a vehicle component 125 is one or more hardware components adapted to perform a mechanical or electro-mechanical function or operation—such as moving the vehicle 105, slowing or stopping the vehicle 105, steering the vehicle 105, etc. Non-limiting examples of components 125 include a propulsion component (that includes, e.g., an internal combustion engine and/or an electric motor, etc.), a transmission component, a steering component (e.g., that may include one or more of a steering wheel, a steering rack, etc.), a brake component, a park assist component, an adaptive cruise control component, an adaptive steering component, a movable seat, etc.

In addition, the computer 110 may be configured for communicating via a vehicle-to-vehicle communications module or interface 130, e.g., a first communications module, with devices outside of the vehicle 105, e.g., through a vehicle-to-vehicle (V2V) or vehicle-to-infrastructure (V2X) wireless communications to another vehicle, to (typically via the network 140) a remote server 145. The communications module 130 could include one or more mechanisms by which the computer 110 may communicate, including any desired combination of wireless (e.g., cellular, wireless, satellite, microwave and radio frequency) communication mechanisms and any desired network topology (or topologies when a plurality of communication mechanisms are utilized). Exemplary communications provided via the module 130 include cellular, Bluetooth®, IEEE 802.11, dedicated short range communications (DSRC), and/or wide area networks (WAN), including the Internet, providing data communication services.

In some implementations of the present disclosure, the vehicle 105 and/or the computing device 135 may also include another communications module or interface 135, e.g., a second communications module, that is in wireless communication with the communications module 130. The communications module 135 could include one or more mechanisms by which the communications module 135 may communicate with the computer 110, including any desired combination of wireless (e.g., cellular, wireless, satellite, microwave and radio frequency) communication mechanisms and any desired network topology (or topologies when a plurality of communication mechanisms are utilized).

In some implementations, the communications module 135 is configured to receive data broadcast by the communications module 130. For instance, a V2X communication device cannot receive its own broadcast message. Therefore, the vehicle 105 and/or infrastructure computing device 150 cannot know whether the messages are sent. Thus, the second communications module 135 can solve this issue since the second communications module 135 can receive messages sent by the first communications module 130.

Within the present context, the communications module 135 operates in a receiver-only mode of operation that only receives messages, which are then provided to the computer 110. As described in great detail herein, the computer 110 can determine whether the communications module 130 is operational or transmitting messages properly based on whether the messages were received by the communications module 135 and/or a message latency associated with the messages.

The network 140 can be one or more of various wired or wireless communication mechanisms, including any desired combination of wired (e.g., cable and fiber) and/or wireless (e.g., cellular, wireless, satellite, microwave, and radio frequency) communication mechanisms and any desired network topology (or topologies when multiple communication mechanisms are utilized). Exemplary communication networks include wireless communication networks (e.g., using Bluetooth, Bluetooth Low Energy (BLE), IEEE 802.11, vehicle-to-vehicle (V2V) such as Dedicated Short-Range Communications (DSRC), etc.), local area networks (LAN) and/or wide area networks (WAN), including the Internet, providing data communication services.

A computer 110 can receive and analyze data from sensors 115 substantially continuously, periodically, and/or when instructed by a server 145, etc. Further, object classification or identification techniques can be used, e.g., in a computer 110 based on lidar sensor 115, camera sensor 115, etc., data, to identify a type of object, e.g., vehicle, person, rock, pothole, bicycle, motorcycle, etc., as well as physical features of objects.

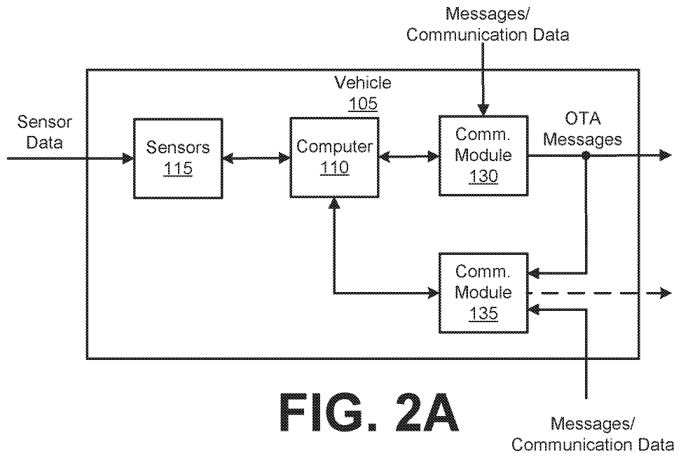

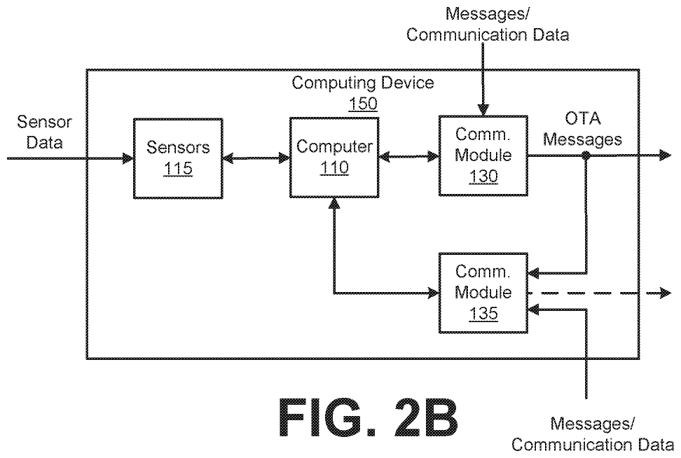

FIGS. 2A and 2B are block diagrams illustrating an example implementation of the vehicle 105 and the computing device 150, respectively, including the communications modules 130, 135. It is understood that the communications modules 130, 135 may include respective processors and memory. The memory includes one or more forms of computer-readable media, and stores instructions executable by the communications modules 130, 135 for performing various operations, including as disclosed herein.

The sensors 115 receive sensor data and output data indicative of the sensed environment to the computer 110. The computer 115 can generate data based on the received data. For instance, the computer 110 can generate control data that is sent to one or more vehicle components 125 based on the received data. The computer 110 can also generate data representing one or more messages based on the data. The messages may be provided to the communications module 130 such that the communications module 130 transmits the messages as output. In one or more implementations, the processor of the communications module 130 may include message scheduling functionality that is configured to cause the communications module 130 to broadcast the messages according to one or more message scheduling protocols. For example, the message scheduling protocols may define when a message, such as a Basic Safety Message (BSM), is to be broadcast. The communications module 130 can include an antenna that transmits the messages to over vehicles and/or devices proximate to the vehicle 105 and/or the computing device 150.

The communications module 135 is configured to receive the messages transmitted by the communications module 130 and sends the received messages to the computer 110. Using the received messages, the computer 110 can monitor one or more vehicle 105 systems or computing device 150 systems. For example, the computer 110 can monitor whether one or more vehicle 105 or computing device 150 systems are operational based on the received messages.

The communications module 135 may also receive messages transmitted from objects proximate to the vehicle 105 or the computing device 150. For example, the communications module 135 may receive Basic Safety Messages (BSMs) transmitted from objects outside of the vehicle 105. For example, the objects may include, but are not limited to, other vehicles, roadside devices, or the like. The BSMs may include positional data representing a position of the object within an environment. For example, the positional data may be coordinates, relative distance values as determined by the objects, or the like. Based on the received messages from the objects, the computer 110 may determine whether the sensors 115 are functioning properly, as described in greater detail below.

In some implementations, the computer 110 is configured to cause the communications module 130 to transmit messages when the computer 110 determines that the vehicle 105 navigation systems are not operational. For example, the computer 110 may cause the communications module 130 to broadcast messages indicating that the vehicle 105 navigation system is not operational when the communications module 130 is not in communication with a sufficient number of satellites.

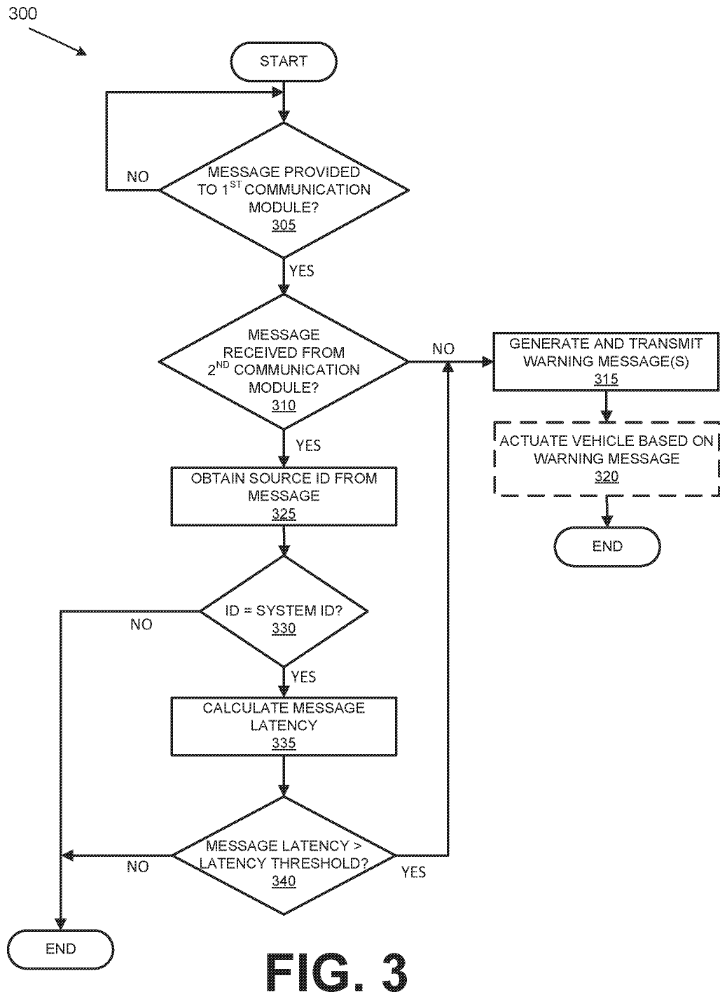

FIG. 3 is a flowchart of an exemplary process 300 for determining whether the communications module 130, e.g., the first communications module, is operational. Blocks of the process 300 can be executed by the computer 110 of the vehicle 105 or the computing device 150. The process 300 begins at block 305 in which a determination is made whether a message is provided to the communications module 130. If no message is provided to the communications module 130, the process 300 returns to block 305. Otherwise, a determination is made whether a message has been received from the communications module 135, e.g., the second communications module, at block 310. In one or more implementations, the communications module 135 continually monitors Over-the-Air messages. If no message has been received from the communications module 135, the computer 110 generates one or more warning messages at block 315. The warning messages may be broadcast to other vehicles proximate to the vehicle 105 or the computing device 150 to indicate the communications module 130 is not operational. For example, the radio antenna in the communication transmitter of the communications module 130 may have malfunctioned. In some implementations, the communications module 135 may be used to transmit the warning messages when the communications module 130 is not operational. The warning messages may also be transmitted to the server 145. The server 145 may send communications to maintenance personnel indicating the communications module 130 is non-operational. In some implementations, the vehicle 105 is actuated based on the warning message at block 320. For instance, the computer 110 causes the vehicle 105 to maneuver to a location such that the vehicle 105 may park until maintenance personnel arrive. In another instance, the computer 110 may cause the vehicle 105 to transition from an autonomous mode of operation to a non-autonomous mode of operation.

If a message is received from the communications module 135, the source identification is obtained from the message at block 325. For instance, the computer 110 can obtain the unique signature of the sending device. In an example implementation, the unique signature comprises a sequence of hex values (e.g., 00-FF), and the computer 110 can filter the received messages according to the unique signature. At block 330, a determination is made whether the source identification corresponds to the system identification. In an example implementation, the computer 110 may maintain a table of system identifications. The computer 110 compares the source identification obtained from the message with the system identifications stored in the table. If the system identification does not correspond to the source identification, the process 300 ends.

Otherwise, a message latency is calculated at block 335. The message latency can be calculated by subtracting a received timestamp (rx_timestamp) from a transmission timestamp (tx_timestamp). The rx_timestamp denotes the timestamp when the message is received by the communications module 135, and the tx_timestamp denotes the timestamp when the message is broadcast by the communications module 130. Since the rx_timestamp and the tx_timestamp are based on the same clock, the latency values are accurate.

At block 340, a determination is made whether the message latency is greater than a predetermined latency threshold. If the message latency is less than or equal to the predetermined latency threshold, the process 300 ends. Otherwise, a warning message is generated and transmitted at block 315. For example, if the latency is larger than the predetermined latency threshold (e.g., 500 milliseconds), it imply that there may be some issue with the message scheduling process. In this example, the computer 110 generates and transmits warning messages to alert other vehicles proximate to the vehicle 105. Additionally, one or more vehicle systems may be actuated based on the warning message at block 320. For instance, the vehicle 105 may transition from the autonomous mode to the non-autonomous mode.

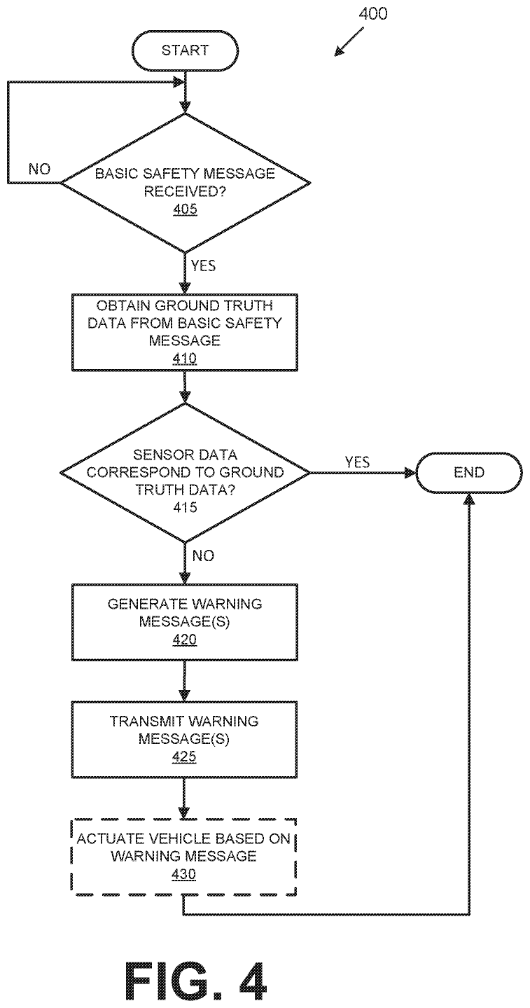

FIG. 4 is a flowchart of an exemplary process 400 for determining whether sensor data received at one or more vehicle 105 sensors 115 is accurate. Blocks of the process 400 can be executed by the computer 110. The process 400 begins at block 405 in which a determination is made whether a message, such as a basic safety message (BSM), has been received. For example, the communications module 130 can receive one to more BSMs from other vehicles, roadside devices, or the like. The BSMs can comprise one or more data packets including ground truth data associated with the transmitting device. For example, the ground truth data may include, but is not limited to, a position associated with the transmitting device, a heading associated with transmitting device, a speed associated with the transmitting device, or the like. If no message is received, the process 400 returns to block 405.

Otherwise, the ground truth data is obtained from the BSM at block 410. For instance, the computer 110 may extract ground truth data from the receives BSMs. A determination is made whether the ground truth data corresponds to the sensor data at block 415. For example, the computer 110 compares the ground truth data to the sensor data to determine whether a difference between the ground truth data and the sensor data is less than a predetermined threshold. In one example, position information within the ground truth data is compared with position information within the sensor data to determine whether a difference is less than the predetermined threshold. A difference greater than the predetermined threshold may be indicative of sensor data corruption.

If the ground truth data corresponds to the sensor data, the process 400 ends. Otherwise, one or more warning messages are generated at block 420. The warning messages can indicate that one or more sensors 115 may be generating corrupted sensor data and/or which sensors are generating corrupted sensor data. At block 425, the warning messages are transmitted via the communications module 130. For example, the warning messages may be broadcast such that other vehicles receive the warning messages indicating the vehicle 105 may not be operating properly. The warning messages may also be transmitted to the server 145 for maintenance request purposes. At block 430, one or more vehicle systems may be actuated based on the warning messages. For instance, the computer 110 may cause the vehicle 105 to pullover and cease driving until the sensor issues are resolved. In another instance, the computer 110 may cause the vehicle 105 to transition from the autonomous mode to the non-autonomous mode.

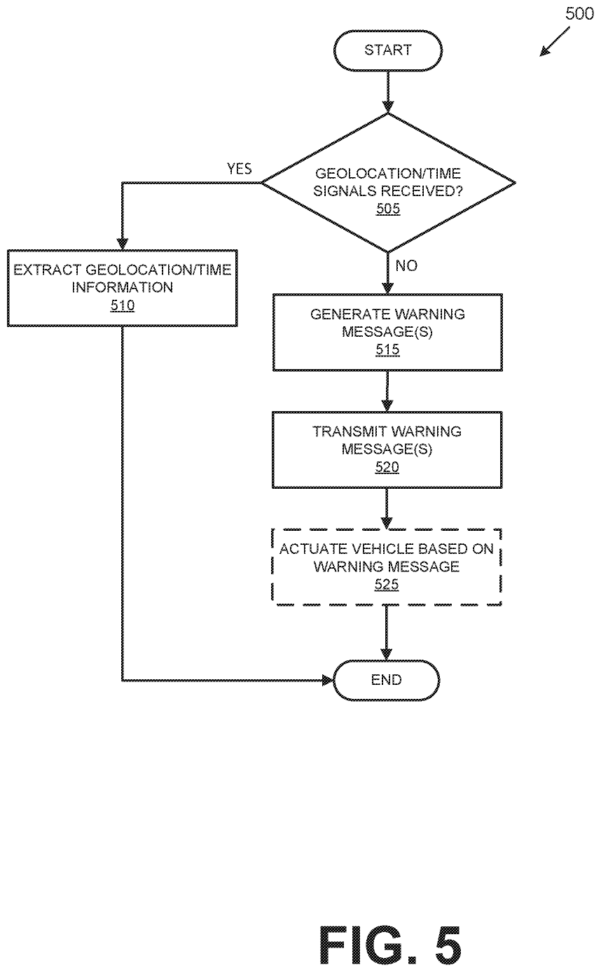

FIG. 5 is a flowchart of an exemplary process 500 for determining whether a sufficient number of Global Positioning System (GPS) signals have been received. Blocks of the process 500 can be executed by the computer 110. The process 500 begins at block 505 in which a determination is made whether GPS signals including geolocation and/or time information has been received from a predetermined number of satellites. For example, the communications module 130 can receive one to more GPS signals including geolocation and/or time information for the vehicle's 105 navigation system. The computer 110 determines whether a sufficient number of GPS signals has been received from a plurality of satellites. For instance, the computer 110 can determine whether GPS signals have been received from at least four (4) satellites that transmit GPS signals.

If GPS signals from a sufficient number of satellites have been received, the geolocation and/or time information is extracted from the GPS signals at block 510. In an example implementation, the geolocation and/or time information can be used for vehicle 105 navigation systems, messages to be generated and transmitted, or the like. Otherwise, one or more warning messages are generated at block 515. The messages may comprise warning information indicating the vehicle 105 has not received GPS signals from a sufficient number of satellites. At block 520, the warning messages are transmitted. For example, the warning messages may be broadcast such that other vehicles receive the warning messages indicating the vehicle 105 may not be operating properly. At block 525, one or more vehicle systems may be actuated based on the warning messages. For instance, the computer 110 may cause the vehicle 105 to pullover and cease driving until GPS signals are received from a sufficient number of satellites. In another instance, the computer 110 may cause the vehicle 110 to transition from the autonomous mode to the non-autonomous mode.

In general, the computing systems and/or devices described may employ any of a number of computer operating systems, including, but by no means limited to, versions and/or varieties of the Ford Sync® application, AppLink/Smart Device Link middleware, the Microsoft Automotive® operating system, the Microsoft Windows® operating system, the Unix operating system (e.g., the Solaris® operating system distributed by Oracle Corporation of Redwood Shores, Calif.), the AIX UNIX operating system distributed by International Business Machines of Armonk, N.Y., the Linux operating system, the Mac OSX and iOS operating systems distributed by Apple Inc. of Cupertino, Calif., the BlackBerry OS distributed by Blackberry, Ltd. of Waterloo, Canada, and the Android operating system developed by Google, Inc. and the Open Handset Alliance, or the QNX® CAR Platform for Infotainment offered by QNX Software Systems. Examples of computing devices include, without limitation, an on-board vehicle computer, a computer workstation, a server, a desktop, notebook, laptop, or handheld computer, or some other computing system and/or device.

Computers and computing devices generally include computer-executable instructions, where the instructions may be executable by one or more computing devices such as those listed above. Computer executable instructions may be compiled or interpreted from computer programs created using a variety of programming languages and/or technologies, including, without limitation, and either alone or in combination, Java™, C, C++, Matlab, Simulink, Stateflow, Visual Basic, Java Script, Perl, HTML, etc. Some of these applications may be compiled and executed on a virtual machine, such as the Java Virtual Machine, the Dalvik virtual machine, or the like. In general, a processor (e.g., a microprocessor) receives instructions, e.g., from a memory, a computer readable medium, etc., and executes these instructions, thereby performing one or more processes, including one or more of the processes described herein. Such instructions and other data may be stored and transmitted using a variety of computer readable media. A file in a computing device is generally a collection of data stored on a computer readable medium, such as a storage medium, a random-access memory, etc.

Memory may include a computer-readable medium (also referred to as a processor-readable medium) that includes any non-transitory (e.g., tangible) medium that participates in providing data (e.g., instructions) that may be read by a computer (e.g., by a processor of a computer). Such a medium may take many forms, including, but not limited to, non-volatile media and volatile media. Non-volatile media may include, for example, optical or magnetic disks and other persistent memory. Volatile media may include, for example, dynamic random-access memory (DRAM), which typically constitutes a main memory. Such instructions may be transmitted by one or more transmission media, including coaxial cables, copper wire and fiber optics, including the wires that comprise a system bus coupled to a processor of an ECU. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

Databases, data repositories or other data stores described herein may include various kinds of mechanisms for storing, accessing, and retrieving various kinds of data, including a hierarchical database, a set of files in a file system, an application database in a proprietary format, a relational database management system (RDBMS), etc. Each such data store is generally included within a computing device employing a computer operating system such as one of those mentioned above, and are accessed via a network in any one or more of a variety of manners. A file system may be accessible from a computer operating system, and may include files stored in various formats. An RDBMS generally employs the Structured Query Language (SQL) in addition to a language for creating, storing, editing, and executing stored procedures, such as the PL/SQL language mentioned above.

In some examples, system elements may be implemented as computer-readable instructions (e.g., software) on one or more computing devices (e.g., servers, personal computers, etc.), stored on computer readable media associated therewith (e.g., disks, memories, etc.). A computer program product may comprise such instructions stored on computer readable media for carrying out the functions described herein.

With regard to the media, processes, systems, methods, heuristics, etc. described herein, it should be understood that, although the steps of such processes, etc. have been described as occurring according to a certain ordered sequence, such processes may be practiced with the described steps performed in an order other than the order described herein. It further should be understood that certain steps may be performed simultaneously, that other steps may be added, or that certain steps described herein may be omitted. In other words, the descriptions of processes herein are provided for the purpose of illustrating certain embodiments, and should in no way be construed so as to limit the claims.

Accordingly, it is to be understood that the above description is intended to be illustrative and not restrictive. Many embodiments and applications other than the examples provided would be apparent to those of skill in the art upon reading the above description. The scope of the invention should be determined, not with reference to the above description, but should instead be determined with reference to the appended claims, along with the full scope of equivalents to which such claims are entitled. It is anticipated and intended that future developments will occur in the arts discussed herein, and that the disclosed systems and methods will be incorporated into such future embodiments. In sum, it should be understood that the invention is capable of modification and variation and is limited only by the following claims.

All terms used in the claims are intended to be given their plain and ordinary meanings as understood by those skilled in the art unless an explicit indication to the contrary in made herein. In particular, use of the singular articles such as “a,” “the,” “said,” etc. should be read to recite one or more of the indicated elements unless a claim recites an explicit limitation to the contrary.

What is claimed is:

1. A system comprising:
a first communications module;
a second communications module communicatively coupled to the first communications module; and
a computer including a processor and a memory, the memory including instructions such that the processor is programmed to:
provide a message to the first communications module, wherein the first communications module is configured to transmit the message;
determine whether the message has been received from the second communications module; and
determine whether to generate a warning message based on the determination of whether the message has been received from the second communications module.

2. The system of claim 1, wherein the processor is further programmed to calculate a message latency corresponding to the message.

3. The system of claim 2, wherein the processor is further programmed to calculate the message latency corresponding to the message by subtracting a received timestamp (rx_timestamp) from a transmission timestamp (tx_timestamp).

4. The system of claim 3, wherein the processor is further programmed to determine whether the message latency is greater than a predetermined latency threshold.

5. The system of claim 4, wherein the processor is further programmed to generate the warning message when the message latency is greater than the predetermined latency threshold.

6. The system of claim 5, wherein the processor is further programmed to cause the warning message to be transmitted via a wireless network to a server.

7. The system of claim 5, wherein the processor is further programmed to cause a vehicle to transition from an autonomous mode to a non-autonomous mode.

8. The system of claim 3, wherein the processor is further programmed to compare source identification information for the message to a system identification to determine whether to calculate the message latency.

9. The system of claim 1, wherein the processor is further programmed to actuate an autonomous vehicle based on the warning message.

10. The system of claim 1, wherein the second communications module operates in a receiver-only mode.

11. A method comprising:
providing a message to a first communications module, wherein the first communications module is configured to transmit the message;
determining whether the message has been received from a second communications module communicatively connected to the first communications module; and
determining whether to generate a warning message based on the determination of whether the message has been received from the second communications module.

12. The method of claim 11, further comprising calculating a message latency corresponding to the message.

13. The method of claim 12, further comprising calculating the message latency corresponding to the message by subtracting a received timestamp (rx_timestamp) from a transmission timestamp (tx_timestamp).

14. The method of claim 13, further comprising determining whether the message latency is greater than a predetermined latency threshold.

15. The method of claim 14, further comprising generating the warning message when the message latency is greater than the predetermined latency threshold.

16. The method of claim 15, further comprising causing the warning message to be transmitted via a wireless network to a server.

17. The method of claim 15, further comprising causing a vehicle to transition from an autonomous mode to a non-autonomous mode based on the warning message.

18. The method of claim 13, further comprising comparing source identification information for the message to a system identification to determine whether to calculate the message latency.

19. The method of claim 11, further comprising actuating an autonomous vehicle based on the warning message.

20. The method of claim 11, wherein the second communications module operates as in a receiver-only mode of operation.
